(19) United States
(12) Patent Application Publication
(10) Pub. No.: US 2022/0301422 A1
(43) Pub. Date: Sep. 22, 2022

(54) ANOMALY DETECTION SYSTEM, ANOMALY DETECTING APPARATUS, ANOMALY DETECTION METHOD AND PROGRAM

(71) Applicant: NIPPON TELEGRAPH AND TELEPHONE CORPORATION, Tokyo (JP)

(72) Inventors: Takafumi HARADA, Tokyo (JP); Keita HASEGAWA, Tokyo (JP); Tomoaki WASHIO, Tokyo (JP); Yoshihito OSHIMA, Tokyo (JP)

(73) Assignee: NIPPON TELEGRAPH AND TELEPHONE CORPORATION, Tokyo (JP)

(21) Appl. No.: 17/636,219

(22) PCT Filed: Sep. 12, 2019
(86) PCT No.: PCT/JP2019/035980

§ 371 Date: Feb. 17, 2022

(51) Int. Cl. G08G 1/01

(52) U.S. Cl. CPC G08G 1/0133; G08G 1/0129; G08G 1/0145

(57) ABSTRACT

An anomaly detection system includes a memory and a processor configured to divide a set of data measured in a geographical space into a plurality of groups that represent a plurality of predetermined geographical subspaces, calculate, for each group, a feature amount in the group using data included in the group, and determine whether or not there is a group that is likely to include abnormal data, among the plurality of groups, using the feature amount in each of the plurality of groups.

### TECHNICAL FIELD

The present invention relates to an anomaly detection system, an anomaly detecting apparatus, an anomaly detection method and a program.

### BACKGROUND ART

In recent years, data indicating sensor values (for example, position information, precipitation, speed information, etc.) measured by various sensors in a specific geographical space or at a specific point have been utilized. In services utilizing such data, there is a growing threat of a False Data Injection attack which attacks a service by injecting data indicating false information (for example, false position information, false precipitation, false speed information, etc.) into a system. To deal with this, a technique has been proposed which detects, as an anomaly, data indicating false information injected by the False Data Injection attack.

For example, a technique has been proposed which detects data indicating false information as an anomaly by calculating feature amounts of data indicating sensor values measured at individual moving objects, and then determining whether the data indicating false information has been injected or not using the feature amounts in a rule-based manner (see Non-Patent Literature 1).

### CITATION LIST

### Non-Patent Literature

Non-Patent Literature 1: Placzek, B. and Bernas, M. (2016). Detection of malicious data in vehicular ad hoc networks for traffic signal control applications. In International Conference on Computer Networks, pages 72-82. Springer.

### SUMMARY OF THE INVENTION

### Technical Problem

However, in the technique described in Non-Patent Literature 1, since target vehicles are analyzed one by one, the calculation cost increases as the number of the target vehicles increases.

An embodiment of the present invention has been made in view of the above problem, and is intended to efficiently detect abnormal data.

### Means for Solving the Problem

To achieve the above object, an anomaly detection system according to the embodiment of the present invention includes: division means for dividing a set of data measured in a geographical space into a plurality of groups that represent a plurality of predetermined geographical subspaces, calculation means for calculating, for each group, a feature amount in the group using data included in the group, and determination means for determining whether or not there is a group that is likely to include abnormal data, among the plurality of groups, using the feature amount in each of the plurality of groups.

### Effects of the Invention

Abnormal data can be efficiently detected.

### BRIEF DESCRIPTION OF DRAWINGS

FIG. 1 is a diagram showing an example of the overall configuration of an anomaly detection system according to the present embodiment.

FIG. 2 is a diagram showing an example of road data stored in a road DB.

FIG. 3 is a diagram showing an example of measurement data stored in a measurement DB.

FIG. 4 is a diagram showing an example of model data stored in a model DB.

FIG. 5 is a diagram showing an example of the hardware configuration of a computer.

FIG. 6 is a flowchart showing an example of a learning process according to the present embodiment.

FIG. 7 is a flowchart showing an example of an anomaly detection process according to the present embodiment.

### DESCRIPTION OF EMBODIMENTS

Hereinafter, an embodiment of the present invention (also referred to as “the present embodiment”) will be described. In the present embodiment, an anomaly detection system 1 will be described which can efficiently detect whether or not abnormal data (hereinafter also referred to as “anomalous data”) is contained in a set of data collected from various sensors, terminals having such sensors, and the like (hereinafter also referred to as “measurement data”). Anomalous data as used herein is data indicating false information, for example, is artificial data which is not actually measured by a sensor, data in which a sensor value measured by a sensor is modified, or the like. In other words, anomalous data as used herein is data indicating a false sensor value (for example, false position information, false precipitation, false speed information, false temperature information, etc.).

The anomaly detection system 1 according to the present embodiment divides a set of measurement data into a plurality of arbitrary groups, and then performs anomaly detection, for each group, using a feature amount calculated from a simple statistic of measurement data included in the group, thereby determining whether or not there is a group in which anomalous data is included. Then, if it is determined that there is a group in which anomalous data is included, the anomaly detection system 1 according to the present embodiment performs more specific anomaly detection (for example, anomaly detection using the technique described in the above Non-Patent Literature 1) on each of measurement data included in this group so as to identify the anomalous data. Therefore, the anomaly detection system 1 according to the present embodiment is able to detect anomalous data more efficiently (thus with less calculation amount), for example, compared to the case where specific anomaly detection (for example, the anomaly detection using the technique described in the above Non-Patent Literature 1) is performed on every measurement data.

Hereinafter, as an example, assuming that a service is provided for supporting optimum route determination for a moving object (for example, a vehicle such as a car or a two-wheeled vehicle, a pedestrian, etc.) moving in a geographical space, a case where a set of measurement data collected from a sensor provided in each moving object is targeted for anomaly detection will be described. Accordingly, it is assumed that measurement data (including anomalous data) contains at least position information and time information. However, this is only an example, and the anomaly detection system 1 according to the present embodiment can efficiently detect anomalous data from a set of any measurement data.

<Overall Configuration>

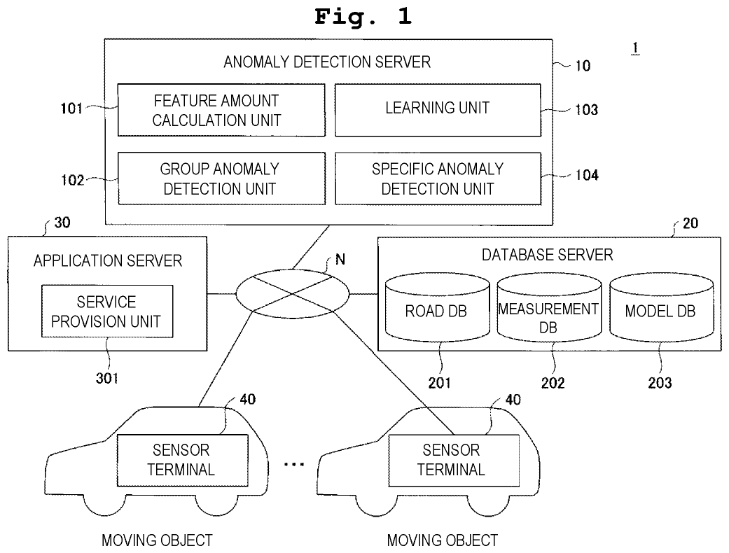

First, the overall configuration of the anomaly detection system 1 according to the present embodiment will be described with reference to FIG. 1. FIG. 1 is a diagram showing an example of the overall configuration of the anomaly detection system 1 according to the present embodiment.

As shown in FIG. 1, the anomaly detection system 1 according to the present embodiment includes an anomaly detection server 10, a database server 20, an application server 30, and a plurality of sensor terminals 40, which are communicably connected via a communication network N. The communication network N includes, for example, the Internet, a LAN (Local Area Network), a sensor network, a mobile phone network, and the like.

The sensor terminal 40 is a sensor or the like provided in a moving object (a vehicle, a pedestrian, or the like). The sensor terminal 40 measures, for example, at least position information at predetermined time intervals, and then sends, to the database server 20, measurement data which contains identification information (for example, a sensor number or the like) identifying the sensor terminal 40, the measured position information, and time information indicating a time at which the position information was measured.

Examples of the sensor terminal 40 include an in-vehicle device, a smartphone, a tablet terminal, a wearable device, and the like.

The database server 20 is a server which has databases (DBs) storing various data. The database server 20 has a road DB 201, a measurement DB 202, and a model DB 203. Each of these DBs can be implemented by using, for example, an auxiliary storage device or the like of the database server 20.

The road DB 201 is a database in which road data is stored. Road data as used herein is data that represents links that constitute a road network. The details of the road data stored in the road DB 201 will be described later.

The measurement DB 202 is a database in which measurement data is stored. The details of the measurement data stored in the measurement DB 202 will be described later.

The model DB 203 is a database in which model data is stored. Model data as used herein is data that represents a model for determining whether or not anomalous data is included in a group of measurement data. The details of the model data stored in the model DB 203 will be described later.

The application server 30 is a server that provides a service which supports optimum route determination (hereinafter also referred to as a “route determination support service”) for a moving object. The application server 30 includes a service provision unit 301. The service provision unit 301 is implemented, for example, by a process which one or more programs installed in the application server 30 cause a processor or the like to execute.

The service provision unit 301 provides a route determination support service to each moving object. The route determination service is, for example, a service that provides an average travel time to a moving object. By recognizing the average travel time, each moving object (or a driver of the moving object or the like) can determine the optimum route.

An average travel time as used herein is the average of times required for traveling a unit distance (for example, 1 km), and is calculated from time information and position information of measurement data stored in the measurement DB 202 (or from speed information calculated from time information and position information). Therefore, for example, if anomalous data has been injected in a set of measurement data by a False Data Injection attack, an erroneous average travel time may be calculated, thus degrading the quality of the route determination support service.

The anomaly detection server 10 is a server that detects whether or not anomalous data is contained in measurement data stored in the measurement DB 202 (i.e., a set of these measurement data). That is, the anomaly detection server 10 detects, as an anomaly, the anomalous data contained in the set of measurement data. The anomaly detection server 10 has a feature amount calculation unit 101, a group anomaly detection unit 102, a learning unit 103, and a specific anomaly detection unit 104. Each of these functional units is implemented, for example, by a process which one or more programs installed in the anomaly detection server 10 cause a processor or the like to execute.

The feature amount calculation unit 101 calculates, for each group of measurement data, a feature amount of a predetermined type from a statistic of measurement data included in the group.

The group anomaly detection unit 102 performs, for each group of measurement data, anomaly detection using the feature amount calculated by the feature amount calculation unit 101. That is, the group anomaly detection unit 102 detects, as an anomaly, a group that is likely to include anomalous data. At this time, in some anomaly detection methods, the group anomaly detection unit 102 also uses model data stored in the model DB 203 to perform the anomaly detection. While a set of measurement data is divided into a plurality of arbitrary groups as described above, the granularity of the division may be, for example, a granularity of the division used in a service (the route determination support service in the present embodiment). For example, the granularity of the division may be in units of links, in units of routes, each of which is made up of a plurality of links, or the like.

The learning unit 103 creates, for each group, model data to be used in anomaly detection to be performed by the group anomaly detection unit 102.

If there is a group in which an anomaly is detected by the group anomaly detection unit 102, the specific anomaly detection unit 104 performs more specific anomaly detection (for example, the anomaly detection using the technique described in the above Non-Patent Literature 1) on each of measurement data included in this group.

The configuration of the anomaly detection system 1 shown in FIG. 1 is only an example, and may be another configuration. For example, some or all of the DBs included in the database server 20 may be included in the anomaly detection server 10, the application server 30, or both. Further, the anomaly detection server 10 and the application server 30 may be, for example, integrally configured.

<Data Stored in DBs>

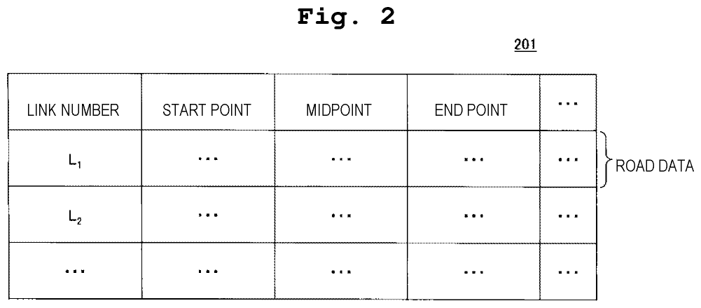

Road data stored in the road DB 201 will be described below with reference to FIG. 2. FIG. 2 is a diagram showing an example of the road data stored in the road DB 201.

As shown in FIG. 2, at least one road data is stored in the road DB 201, and each road data contains “link number”, “start point”, “midpoint”, “end point”, and the like.

The link number is identification information that identifies a link. A link as used herein is a component of a road network, for example, a line or a curve representing a road connecting between nodes. A node as used herein is a component of a road network, for example, coordinates representing a specific point (such as an intersection or a corner).

The start point is coordinates representing the start point of a link. The midpoint is coordinates representing the midpoint of a link. The end point is coordinates representing the end point. The travel direction of a road represented by a link is represented by the direction from a start point to an end point.

As described above, at least one road data is stored in the road DB 201, and each road data contains, for each link number, various information about a link of the link number. In addition to the above-described information, each road data may include, for example, information such as “road type”, “road width”, “the number of lanes”, “gradient”, and “curvature radius”. A road type as used herein is the type of a road represented by a link, for example, information representing a road type such as an expressway or a general road. A road width as used herein is the width of a road represented by a link. The number of lanes as used herein is the number of lanes of a road represented by a link. A gradient as used herein is the gradient of a road represented by a link. A curvature radius as used herein is the curvature radius of a road represented by a link.

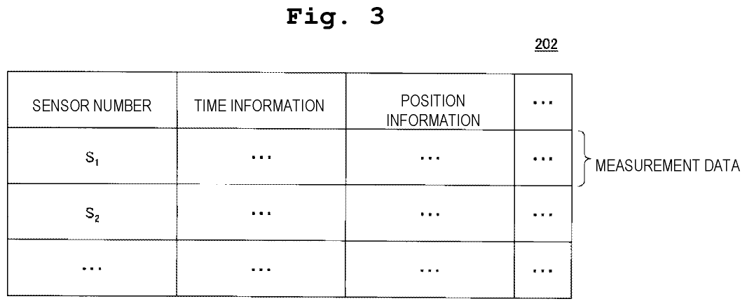

Next, measurement data stored in the measurement DB 202 will be described with reference to FIG. 3. FIG. 3 is a diagram showing an example of the road data stored in the measurement DB 202.

As shown in FIG. 3, at least one measurement data is stored in the measurement DB 202, and each measurement data contains “sensor number”, “time information”, “position information”, and the like.

The sensor number is identification information that identifies a sensor terminal 40 which has sent the relevant measurement data. The time information is information representing a time at which the relevant sensor terminal 40 measured position information. The position information is information indicating a position measured by the relevant sensor terminal 40 (i.e., the position of the sensor terminal 40).

As described above, at least one measurement data is stored in the measurement DB 202, and each measurement data contains information about a sensor value (for example, position information) measured by the sensor terminal 40. In addition to the above-described information, each measurement data may contain various sensor values (for example, temperature, humidity, etc.) measured by the sensor terminal 40, and may contain information calculated from these sensor values (for example, the link number of a link to which a moving object having the sensor terminal 40 belongs, the travel speed of the moving object, etc.). Further, information calculated from these sensor values may be calculated by the sensor terminal 40 or the database server 20. A travel speed may also be referred to as a “moving speed” or the like.

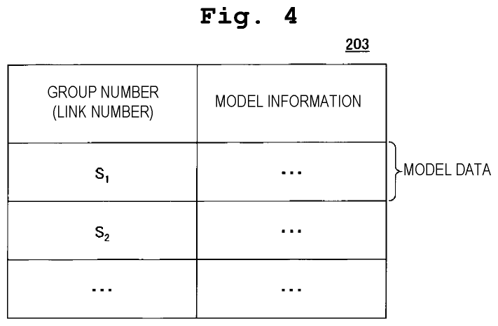

Next, model data stored in the model DB 203 will be described with reference to FIG. 4. FIG. 4 is a diagram showing an example of the model data stored in the model DB 203.

As shown in FIG. 4, at least one model data is stored in the model DB 203, and each model data contains “group number”, “model information”, and the like.

The group number is identification information that identifies one of groups into which a set of measurement data is divided. Although a set of measurement data can be divided into a plurality of arbitrary groups as described above, it is assumed that a set of measurement data is divided in terms of geographical space in the present embodiment. Specifically, in the present embodiment, it is assumed that each of links is considered as one group, and corresponding to the links to which position information contained in measurement data belongs, a set of measurement data is divided into respective groups (in other words, it is assumed that as the granularity of the division into groups, division granularity in units of links is adopted). Accordingly, in the present embodiment, a group number is a link number.

However, the above group division is only an example, and in a further example, after a geographical space is divided into arbitrary areas (e.g., a rectangular area, a polygonal area, etc.), a set of measurement data may be divided into respective groups corresponding to the areas to which position information belongs, and a set of measurement data may also be divided into respective groups by Voronoi partition, division at each road branch, or the like.

The model information is information representing a model for detecting whether or not anomalous data is contained in measurement data to which a group corresponding to a group number belongs. Such model information is calculated for each group from the learning unit 103 using measurement data for learning. The model information obtained here differs depending on the anomaly detection method used by the group anomaly detection unit 102.

For example, in a case where the group anomaly detection unit 102 performs anomaly detection by One Class SVM (Support Vector Machine), normal data is used as measurement data for learning, and information (for example, average travel speed at each time and vehicle density at each time) represented by these normal data is used as model information. Normal data as used herein is measurement data that is not anomalous data. An average travel speed at each time as used herein is the average travel speed at each time of moving objects belonging to the relevant link. Vehicle density at each time as used herein is the density of moving objects at each time on the relevant link.

Although in the present embodiment, anomaly detection is performed by a One Class SVM assuming that anomalous data can hardly be obtained as measurement data for learning, anomaly detection may be performed by an SVM (Support Vector Machine) in a case where anomalous data can be obtained as measurement data for learning as with normal data.

However, model information is not required in a case where the group anomaly detection unit 102 performs anomaly detection by a method that does not need model information. In this case, the database server 20 does not necessarily need to have the model DB 203. Therefore, in this case, the anomaly detection server 10 does not necessarily need to have the learning unit 103.

As described above, at least one model data is stored in the model DB 203, and each model data contains, for each group, model information for performing anomaly detection with respect to the group. In addition to the above-described information, each model data may contain information for specifying the range of the relevant group (for example, in a case where each group is represented as a polygonal area, its vertex coordinates or the like).

Further, model data may contain a plurality of model information. For example, when the plurality of model information is contained in the model data, anomaly detection may be performed using each of the plurality of model information, and a majority vote of the results of the anomaly detection or the like may be used to obtain the final anomaly detection result.

<Hardware Configuration>

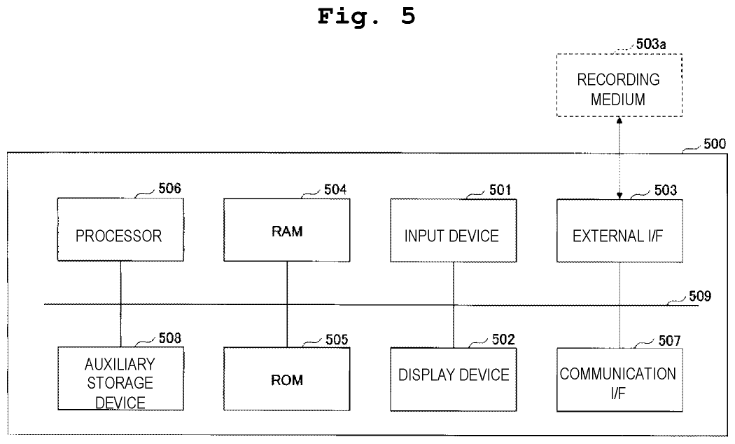

Next, there will be described hardware configurations of the anomaly detection server 10, the database server 20, and the application server 30 included in the anomaly detection system 1 according to the present embodiment. The anomaly detection server 10, the database server 20, and the application server 30 have, for example, the hardware configuration of a computer 500 shown in FIG. 5. FIG. 5 is a diagram showing an example of the hardware configuration of the computer 500.

The computer 500 shown in FIG. 5 includes an input device 501, a display device 502, an external I/F 503, a Random Access Memory (RAM) 504, a Read Only Memory (ROM) 505, a processor 506, a communication I/F 507, and an auxiliary storage device 508. These hardware devices are communicably interconnected by a bus 509.

The input device 501 is, for example, a keyboard, a mouse, a touch panel, various operation buttons, or the like. The display device 502 is, for example, a display or the like. The computer 500 does not necessarily need to have at least one of the input device 501 and the display device 502.

The external I/F 503 is an interface with an external device such as a recording medium 503a. Examples of the recording medium 503a include a CD, a DVD, an SD memory card, a USB memory, and the like.

The RAM 504 is a volatile semiconductor memory that temporarily holds a program and data. The ROM 505 is a non-volatile semiconductor memory that stores various programs and data. The processor 506 is, for example, any type of arithmetic unit such as a Central Processing Unit (CPU).

The communication I/F 507 is an interface for connecting the computer 500 to the communication network N. The auxiliary storage device 508 is, for example, any type of storage device such as a Hard Disk Drive (HDD) or a Solid State Drive (SSD).

Since the anomaly detection server 10, the database server 20, and the application server 30 according to the present embodiment have the hardware configuration of the computer 500 shown in FIG. 5, they can implement various processes described later. However, the hardware configuration shown in FIG. 5 is only an example, and the computer 500 may have another hardware configuration. For example, the computer 500 may have a plurality of auxiliary storage devices 508 or a plurality of processors 506.

<Details of Processing>

Next, details of processing executed by the anomaly detection server 10 included in the anomaly detection system 1 according to the present embodiment will be described.

<<Learning Process>>

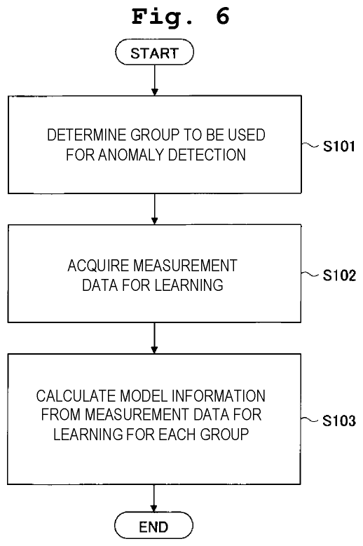

First, a learning process for creating model information for each group will be described with reference to FIG. 6. FIG. 6 is a flowchart showing an example of a learning process according to the present embodiment. This learning process is executed in advance before an anomaly detection process described later. Hereinafter, it is assumed that measurement data for learning is stored in the measurement DB 202. It is noted that in the case where the group anomaly detection unit 102 performs anomaly detection by a method that does not need model information, this learning process is not executed as described above.

First, the learning unit 103 determines a group to be used for anomaly detection (step S101). As described above, in the present embodiment, each of links is determined as a group to be used for anomaly detection. Thus, the learning unit 103 acquires road data from the road DB 201, and then determines a link represented by each of these road data as a group. At this time, the learning unit 103 also determines group numbers of these groups.

Next, the learning unit 103 acquires the measurement data for learning from the measurement DB 202 (step S102). As described above, in the present embodiment, it is assumed that anomaly detection is performed by One Class SVM, and it is assumed that teaching data is not associated with the measurement data for learning. In addition, it is assumed that most (or all) of these measurement data for learning is normal data. Hereinafter, for the sake of simplicity, measurement data for learning will be also referred to simply as “learning data”.

Next, the learning unit 103 divides the learning data in units of groups determined in the above step S101, and then calculates, for each group, model information from learning data belonging to the group (step S103). Then, the learning unit 103 stores model data in which the group number and the model information are contained, into the model DB 203. As described above, the learning unit 103 calculates, for each group, certain specific information (for example, average travel speed at each time and vehicle density at each time) from learning data included in the group, thereby calculating such information as model information. Hereinafter, it is assumed that model information is average travel speed at each time and vehicle density at each time.

The average travel speed at each time of a certain group is calculated by dividing the sum at each time of travel speeds corresponding to respective learning data included in the group by the number of learning data included in the group. A travel speed corresponding to learning data as used herein is, in a case where a travel speed is contained in the learning data, set to this travel speed, and in a case where no travel speed is contained in the learning data, set to a travel speed calculated from position information and time information contained in respective learning data having the same sensor number.

Vehicle density at each time of a certain group is calculated by dividing the sum at each time of travel speeds corresponding to respective learning data included in the group by the distance of a link corresponding to the group.

In this way, the anomaly detection system 1 according to the present embodiment can create model data representing model information for each group from learning data, and store the model data in the model DB 203. As described later, in the anomaly detection process, anomaly detection is performed in units of groups using these model data.

«Anomaly Detection Process>>

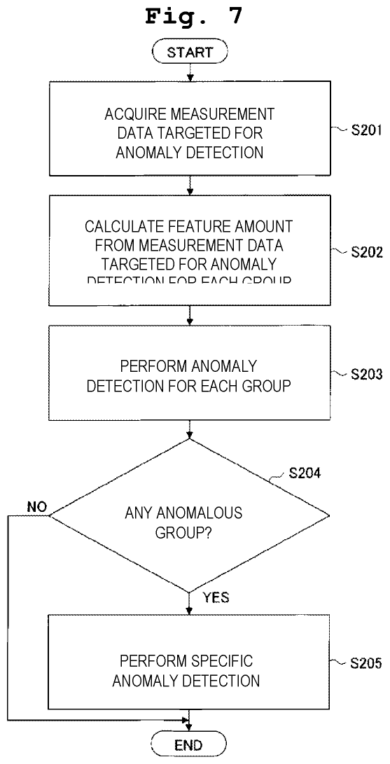

Next, the anomaly detection process for detecting whether or not anomalous data is included in a set of measurement data will be described with reference to FIG. 7. FIG. 7 is a flowchart showing an example of the anomaly detection process according to the present embodiment.

First, the feature amount calculation unit 101 acquires measurement data containing time information indicating a certain specific time (for example, the current time) from the measurement DB 202, as measurement data targeted for anomaly detection (step S201).

Next, the feature amount calculation unit 101 divides the measurement data acquired in the above step S201 into predetermined groups (i.e., the groups determined in step S101 of FIG. 6). Then, the feature amount calculation unit 101 calculates, for each group, a feature amount of a predetermined type from a statistic of measurement data included in the group (step S202). Thus, the feature amount is calculated for each group. As the statistic of the measurement data included in the group, a statistic according to the type of the feature amount is used here, for example, a simple statistic such as the number of measurement data belonging to the group, the sum of travel speeds, or the sum of travel times, is used. The details of the feature amount will be described later.

Next, the group anomaly detection unit 102 determines, for each group, whether or not the group is anomalous (i.e., whether or not anomalous data is included in the group) using the feature amount calculated in the above step S202 and the model data stored in the model DB 203 (step S203). For example, the group anomaly detection unit 102 determines, for each group, whether the group is anomalous or not by performing anomaly detection by One Class SVM using the feature amount in the group and the model information in the group. At this time, the group anomaly detection unit 102 may perform anomaly detection using all of the feature amounts in the group, or may perform anomaly detection using some of the feature amounts step by step.

For example, since the traffic condition of a moving object may change due to various factors such as time, weather, and a season, it may be difficult to properly represent a normal area (that is, an area represented by model information). Therefore, for example, the contribution rate to the normal area may be calculated for each factor affecting the traffic condition, and the normal area may be defined by using a combination of these contribution rates. In other words, the group anomaly detection unit 102 may use the contribution rate of each factor to correct the result of anomaly detection obtained by using each model information.

Next, the group anomaly detection unit 102 determines whether or not there is an anomalous group (i.e., a group determined to be anomalous) in the above step S203 (step S204).

If it is not determined in the above step S204 that there is an anomalous group, the anomaly detection server 10 ends the anomaly detection process. On the other hand, if it is determined in the above step S204 that there is an anomalous group, the specific anomaly detection unit 104 performs more specific anomaly detection for each of measurement data included in the group determined to be anomalous (step S205). More specific anomaly detection may be, for example, the anomaly detection using the technique described in the above Non-Patent Literature 1 or may be anomaly detection using another conventional technique. Alternatively, anomaly detection may be performed by, for example, comparing measurement data in the vicinity among measurement data included in the group determined to be anomalous.

As described above, the anomaly detection system 1 according to the present embodiment performs anomaly detection in units of groups, and if an anomaly is detected by this anomaly detection, performs more specific anomaly detection on each of measurement data belonging to the group in which the anomaly is detected. Therefore, the anomaly detection system 1 according to the present embodiment is able to detect anomalous data more efficiently compared to, for example, a case where specific anomaly detection is performed on every measurement data. The anomaly detection process shown in FIG. 7 is repeatedly executed at each predetermined time (for example, every unit time) until a predetermined period elapses, for example.

<Feature Amounts>

The details of feature amounts calculated in step S202 of FIG. 7 will be described below. The feature amount calculation unit 101 uses measurement data acquired in step S201 of FIG. 7 (i.e., measurement data that contains time information indicating a certain specific time) to calculate, for example, a feature amount shown in any of the following (1) to (3).

(1) Knowledge-based Feature Amounts

Average travel speed for each group and vehicle density for each group can be used as basic feature amounts in a group of moving objects which moves in a geographical space. This is because the average travel speed and the vehicle density are strongly influenced by physical characteristics of a road such as a road width, the number of lanes, a gradient, and a curvature radius, and therefore do not change significantly unless the structure of the road is changed. That is, the average travel speed and the vehicle density do not change significantly, for example, by passage of time unless the physical characteristics of the road change.

The feature amount calculation unit 101 calculates the average travel speed and the vehicle density as feature amounts for each of groups (i.e., links) in the following Step 1-1 to Step 1-3.

Step 1-1: The feature amount calculation unit 101 calculates, for each group, the number of measurement data included in the group (this is also referred to as a “first statistic”). Further, the feature amount calculation unit 101 calculates, for each group, the distance of a link corresponding to the group (this is also referred to as a “second statistic”).

Step 1-2: The feature amount calculation unit 101 calculates, for each group, the sum of travel speeds corresponding to each measurement data included in the group (this is also referred to as a “third statistic”), and then calculates an average travel speed by dividing the third statistic by the first statistic. A travel speed corresponding to measurement data as used herein is, in a case where a travel speed is contained in the data, set to this travel speed, and in a case where no travel speed is contained in the data, set to a travel speed calculated from position information and time information contained in past measurement data having the same sensor number.

Step 1-3: The feature amount calculation unit 101 calculates, for each group, vehicle density by dividing the third statistic by the second statistic.

Although the sum of travel speeds corresponding to each measurement data included in the group is defined as the third statistic in the above Step 1-2, the statistic is not limited to this, and for example, a value that can be calculated with the movement of a moving object (for example, an elapsed time since the moving object enters a link (i.e., the travel time of the moving object within the link) or the like) may be used as the third statistic.

(2) Temporal Feature Amount

Generally, the average travel speed calculated above in (1) changes dynamically according to, for example, a time zone, a season, a day of the week, weather, and the like. For example, because daytime traffic on holidays is generally greater than daytime traffic on weekdays, the average travel speed decreases accordingly. Further, for example, on an expressway, because the traffic increases in association with commuting in morning and evening while the traffic decreases in early morning and late night, the average travel speed decreases in morning and evening while the average travel speed increases early morning and late night. The same applies to vehicle density.

While the average travel speed and vehicle density can dynamically change due to various factors as described above, the most important factor is time. In view of this, as feature amounts which are less affected by time factors, the difference value of average travel speed and the difference value of vehicle density, and the time rate of change of average travel speed and the time rate of change of vehicle density can be used. By using these feature amounts, the occurrence of false detection due to time factors (for example, a situation in which normal measurement data is detected as anomalous data) can be reduced.

In the following Step 2-1 to Step 2-4, the feature amount calculation unit 101 calculates, for each of groups (i.e., links), as feature amounts, the difference value of average travel speed and the difference value of vehicle density, and the time rate of change of average travel speed and the time rate of change of vehicle density.

Step 2-1: The feature amount calculation unit 101 calculates, for each group, average travel speed and vehicle density as in (1) as described above.

Step 2-2: The feature amount calculation unit 101 acquires, for each group, model information from model data stored in the model DB 203.

Step 2-3: The feature amount calculation unit 101 calculates, for each group, the difference between the average travel speed calculated in the above Step 2-1 and the average travel speed contained in the model information, and sets this difference value as the difference value of the average travel speed in the group. Similarly, the feature amount calculation unit 101 calculates, for each group, the difference between the vehicle density calculated in the above Step 2-1 and the vehicle density contained in the model information, and sets this difference value as the difference value of the vehicle density in the group. It is assumed here that the vehicle density and the average travel speed in normal times are obtained as model information in advance by observation, simulation, or the like.

Step 2-4: The feature amount calculation unit 101 sets the rate of change between the previously calculated average travel speed and the average travel speed calculated in the above Step 2-1, as the time rate of change of the average travel speed. Similarly, the feature amount calculation unit 101 sets the rate of change between the previously calculated vehicle density and the vehicle density calculated in the above Step 2-1, as the time rate of change of the vehicle density. Previously calculated average travel speed and vehicle density used herein are the average travel speed and vehicle density calculated in step S202 of the anomaly detection process executed immediately before, while the anomaly detection process shown in FIG. 7 is repeatedly executed.

The third statistic may be, for example, a value that can be calculated with the movement of a moving object as in (1) as described above.

(3) Spatial Feature Amounts

Generally, it is known that the time variation of vehicle density shows high correlation between links existing in the vicinity. On the other hand, even if links are in the vicinity, the links may have a low correlation due to the difference in the traffic capacity of links (that is, the maximum number of vehicles that can pass through a certain road section per unit time, for example), or connectivity to other links. Such spatial correlation can occur due to a plurality of factors, but the correlation between links does not change by passage of time.

Therefore, by setting a threshold for each of average travel speed and vehicle density, a plane represented by the average travel speed and the vehicle density is divided into four areas, and correlation coefficients on the four areas are calculated for each group, and cumulative values of these correlation coefficients may be used as feature amounts. While the above-described threshold can be arbitrarily set for each group, a threshold for average travel speed may be set to, for example, “20 km/h”, which is a condition of traffic jam on the Metropolitan Expressway, and a threshold for vehicle density may be set to the average vehicle density of the road at the speed of the above condition.

An area where the average travel speed is less than the threshold and the vehicle density is greater than or equal to the threshold represents a traffic jam phase, an area where the average travel speed is greater than or equal to the threshold and the vehicle density is less than the threshold represents a free flow phase, and an area other than the traffic jam phase and the free flow phase represents a transition state between the traffic jam phase and the free flow phase. Therefore, the above-described four areas are also referred to as “the first state” to “the fourth state”, respectively.

The feature amount calculation unit 101 calculates the cumulative value of a correlation coefficient as a feature for each of groups (e.g., links in the present embodiment) in the following Step 3-1 to Step 3-4.

Step 3-1: The feature amount calculation unit 101 calculates, for each group, average travel speed and vehicle density as in (1) as described above.

Step 3-2: The feature amount calculation unit 101 determines, for each group, the state of the group among the first to fourth states using the average travel speed and vehicle density calculated in the above Step 3-1. However, the four states are an example, and more states may be defined, and the states do not necessarily need to be discrete.

Step 3-3: The feature amount calculation unit 101 calculates a correlation coefficient between groups, for example, with respect to vehicle density. Thereby, for example, a correlation coefficient rₖⱼ about the vehicle density between a group k and a group j is calculated.

Step 3-4: The feature amount calculation unit 101 sets, for each group, the cumulative value (statistic) of the correlation coefficient between the group and another group, as a feature amount. Specifically, for example, when calculating the feature amount in the group k, the feature amount calculation unit 101 calculates the cumulative value of rₖⱼ for all j, as a feature amount. At this time, the feature amount calculation unit 101 may calculate the cumulative value by adding rₖⱼ if the states of the group k and the group j are the same, and subtracting it (that is, adding −rₖⱼ) if not the same.

Although the average travel speed is used in the above description, any feature amount representing traffic flow speed such as average travel time may be used. Further, although the vehicle density is used in the above description, any feature amount representing flow volume such as traffic volume may be used.

The present invention is not limited to the above-described embodiments disclosed specifically, and various modifications and changes can be made without departing from the description of the claims.

### REFERENCE SIGNS LIST

1 Anomaly detection system
10 Anomaly detection server
20 Database server
30 Application server
40 Sensor terminal
101 Feature amount calculation unit
102 Group anomaly detection unit
103 Learning unit
104 Specific anomaly detection unit
201 Road DB
202 Measurement DB
203 Model DB
301 Service provision unit

1. An anomaly detection system comprising:
a memory; and
a processor configured to
divide a set of data measured in a geographical space into a plurality of groups that represent a plurality of predetermined geographical subspaces;
calculate, for each group, a feature amount in the group using data included in the group; and
determine whether or not there is a group that is likely to include abnormal data, among the plurality of groups, using the feature amount in each of the plurality of groups.

2. The anomaly detection system according to claim 1, wherein
the data is data obtained by measuring position information of a moving object at each predetermined time, and
the processor is configured to calculate, as the feature amounts, a flow speed of traffic represented by data included in the group and a flow volume of traffic in the geographical subspace which the group represents.

3. The anomaly detection system according to claim 2, wherein the processor is configured to calculate, as the feature amounts, at least one of: a time variation of the flow speed and a time variation of the flow volume; or a difference between the flow speed and its normal flow speed and a difference between the flow volume and its normal flow volume.

4. The anomaly detection system according to claim 2, wherein the processor is configured to calculate the feature amount using a correlation value of the flow volume or the flow speed between the groups.

5. The anomaly detection system according to claim 1, wherein the processor is configured to divide the set into the plurality of groups so that a plurality of arbitrary areas set by a user according to the data or a plurality of areas set by a service that has used the data are the plurality of geographical subspaces.

6. An anomaly detection apparatus comprising:
a memory; and
a processor configured to
divide a set of data measured in a geographical space into a plurality of groups that represent a plurality of predetermined geographical subspaces;
calculate, for each group, a feature amount in the group using data included in the group; and
determine whether or not there is a group in which abnormal data is included, among the plurality of groups, using the feature amount in each of the plurality of groups.

7. An anomaly detection method wherein a computer executes:
dividing a set of data measured in a geographical space into a plurality of groups that represent a plurality of predetermined geographical subspaces;
calculating, for each group, a feature amount in the group using data included in the group; and
determining whether or not there is a group that is likely to include abnormal data, among the plurality of groups, using the feature amount in each of the plurality of groups.

8. A non-transitory computer-readable recording medium having a program stored thereon for causing a computer to execute the anomaly detection method of claim 7.
